(19) United States
(12) Patent Application Publication
(10) Pub. No.: US 2010/0101818 A1
(43) Pub. Date: Apr. 29, 2010

(54) HYBRID ELECTRICAL COVER PLATE

(75) Inventor: Huang JUNJIE, Fujian (CN)

Correspondence Address: PILLSBURY WINTHROP SHAW PITTMAN, LLP, P.O. BOX 10500, MCLEAN, VA, 22102, US

(73) Assignee: FUZHOU JJ INDUSTRIES, INC., Fuzhou (CN)

(21) Appl. No.: 12/256,833

(22) Filed: Oct. 23, 2008

(51) Int. Cl. H02G 3/14

(52) U.S. Cl. 174/66

(57) ABSTRACT

An electrical plate is disclosed that is configured to mate a rectangular electrical box and a circular electrical box, wherein the electrical plate has a profile that covers both the rectangular electrical box and the circular electrical box. The electrical plate includes holes pattered to mate with the holes in both the rectangular electrical box and the circular electrical box to receive screws that attach the electrical plate to either electrical box.

### FIELD OF THE INVENTION

The present invention relates to the field of electrical circuitry housings, and more in particular to an electrical plate configured to cover an electrical circuit box and receive an electrical device.

### BACKGROUND OF THE INVENTION

The walls, ceilings and floors of residential and commercial buildings include electrical cables to provide power to external electrical devices. Within the building, these electrical cables extend into and terminate within boxes that are recessed into the wall, ceiling or floor. Electrical devices then connect to the terminated electrical cables within the box. These boxes are typically made from pressed sheet metal or injection molded plastic. Typically, these boxes are either rectangular or have a round configuration. These boxes are typically recessed into the walls, ceilings and floor of the building and are covered with an electrical cover plate. The electrical cover plate covers the box, thereby hiding and protecting the electrical circuitry connections formed between the external devices and the electrical cables terminating within the box. In addition, the electrical cover plate can provide structural support for mounting various electrical devices.

### SUMMARY OF THE INVENTION

An electrical plate is disclosed that is configured to mate a rectangular electrical box and a circular electrical box, wherein the electrical plate has a profile that covers both the rectangular electrical box and the circular electrical box. The electrical plate includes holes pattered to mate with the holes in both the rectangular electrical box and the circular electrical box to receive screws that attach the electrical plate to either electrical box.

According to one embodiment of the invention, a plate for covering either a rectangular electrical box or a circular electrical box is disclosed. The plate includes a circular plate cover portion configured cover a circular electrical box and a rectangular plate cover portion configured to cover a rectangular electrical box. The plate may further includes a first threaded hole formed in the plate for receiving an electrical device. In addition, a plurality of holes may be formed in the plate for receiving a fastener to secure the plate to the circular or rectangular electrical box. The plurality of holes may include a first pattern of holes configured to match the hole pattern of the circular electrical box. The plurality of holes may also include a second pattern of holes configured to match the hole pattern of the rectangular electrical box. The plate may also include a threaded plug configured to mate with the threaded hole. Further, the plate can also include a second threaded hole and a third threaded hole, wherein the first threaded hole has an axis perpendicular to a rear surface of the plate, and wherein the second and third threaded holes have an axis that is angled with respect to the axis of the first threaded hole.

In another embodiment, an electrical plate configured to mate with both a circular electrical box and a rectangular electrical box is disclosed, wherein said electrical plate has an exterior profile configured to cover both the circular electrical box and a rectangular electrical box.

In a further embodiment of the invention, an electrical plate for covering a round electrical box or a rectangular electrical box is disclosed. The electrical plate includes a plate having two ends and two sides, each end having three flat edges configured to match a configuration of the rectangular electrical box, each side having curved edges configured to match a configuration of the round electrical box.

Other objects, features and aspects of the invention will become apparent from the following detailed description, the accompanying drawings, and the appended claims.

### BRIEF DESCRIPTION OF THE DRAWINGS

The novel features that are considered characteristic of the invention are set forth with particularity in the appended claims. The invention itself; however, both as to its structure and operation together with the additional objects and advantages thereof are best understood through the following description of the preferred embodiment of the present invention when read in conjunction with the accompanying drawings, wherein:

FIG. 1 illustrates a front view of an electrical plate in accordance with a preferred embodiment of the invention;

FIG. 2 illustrates a rear view of an electrical plate in accordance with a preferred embodiment of the invention;

FIG. 3 illustrates a side view of an electrical plate in accordance with a preferred embodiment of the invention;

FIG. 4 illustrates another side view of an electrical plate in accordance with a preferred embodiment of the invention;

FIG. 5 illustrates a bottom view of an electrical plate in accordance with a preferred embodiment of the invention;

FIG. 6 illustrates a top view of an electrical plate in accordance with a preferred embodiment of the invention;

FIG. 7 illustrates a front view of an electrical plate in accordance with an alternative embodiment of the invention;

FIG. 8 illustrates a rear view of an electrical plate in accordance with an alternative embodiment of the invention;

FIG. 9 illustrates a side view of an electrical plate in accordance with an alternative embodiment of the invention;

FIG. 10 illustrates another side view of an electrical plate in accordance with an alternative embodiment of the invention;

FIG. 11 illustrates a bottom view of an electrical plate in accordance with an alternative embodiment of the invention;

FIG. 12 illustrates a top view of an electrical plate in accordance with an alternative embodiment of the invention;

FIG. 13 illustrates an exploded view of an electrical plate and three threaded plugs in accordance with an alternative embodiment of the invention;

FIG. 14 illustrates an exploded view of an electrical plate in accordance with a preferred embodiment of the invention and a rectangular electrical box and lighted motion detector apparatus;

FIG. 15 illustrates an exploded view of an electrical plate in accordance with an alternative embodiment of the invention and a circular electrical box and lighted motion detector apparatus;

FIG. 16 illustrates an exploded view of an electrical plate and three threaded bases of a lighted motion detector apparatus in accordance with an alternative embodiment of the invention;

FIG. 17 illustrates a front view of an electrical plate in accordance with a preferred embodiment of the invention and a pair of lights;

FIG. 18 illustrates a front view of an electrical plate in accordance with an alternative embodiment of the invention and a pair of lights;

FIG. 19 illustrates a front view of an electrical plate in accordance with a preferred embodiment of the invention and a lighted motion detector apparatus;

FIG. 20 illustrates a front view of an electrical plate in accordance with an alternative embodiment of the invention and a lighted motion detector apparatus; and

FIG. 21 illustrates a rear perspective view of an electrical plate in accordance with an alternative embodiment of the invention.

### DETAILED DESCRIPTION

While the invention has been shown and described with reference to a particular embodiment thereof, it will be understood to those skilled in the art, that various changes in form and details may be made therein without departing from the spirit and scope of the invention.

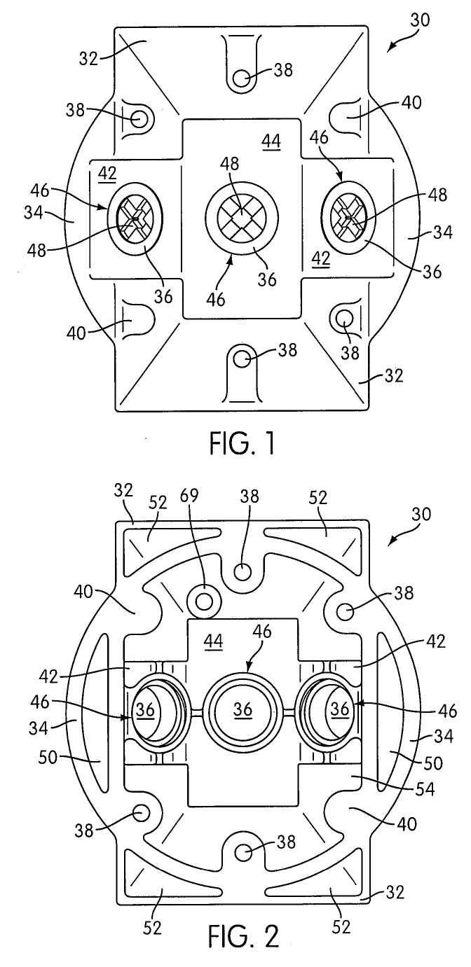

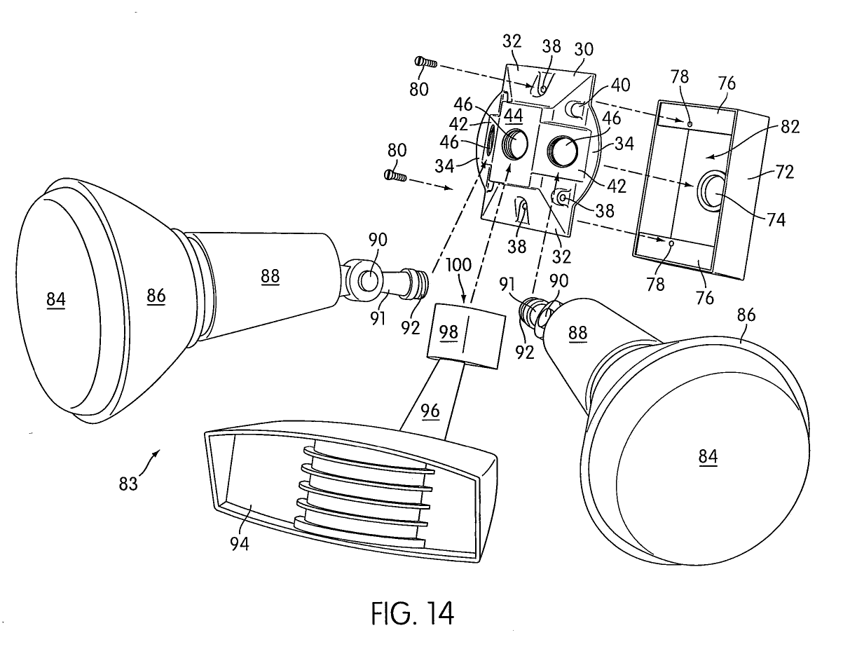

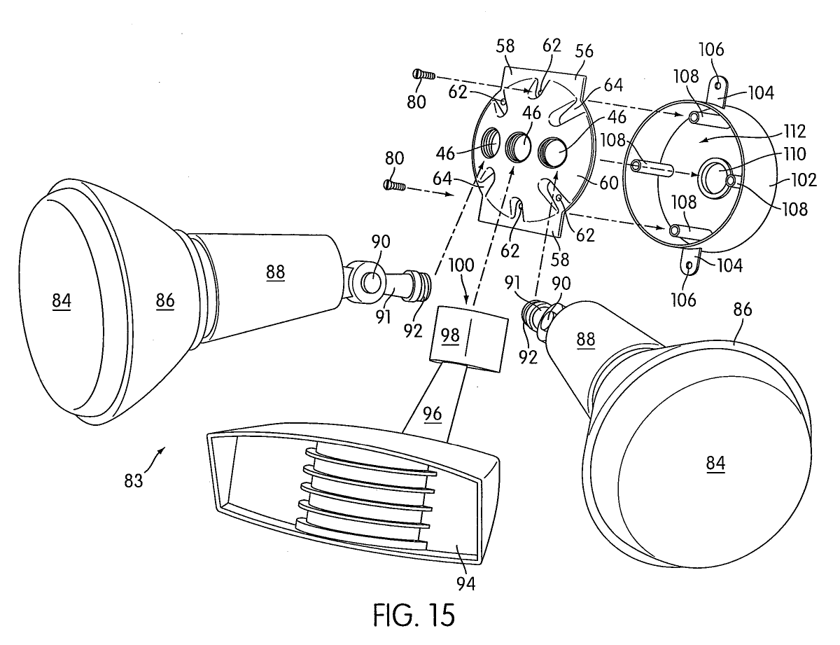

FIG. 1 illustrates a front view of an electrical plate 30 in accordance with a preferred embodiment of the invention. Electrical plate 30 is a cover used to mate with an electrical box 72 or 102 illustrated in FIGS. 14 and 15. Electrical plate 30 is a hybrid plate that includes both a rectangular plate cover portion 32 and a circular plate cover portion 34. Electrical plate 30 includes three threaded plugs 36 that mate with electrical plate 30. Various holes 38 are formed in electrical plate 30 to receive screws 80, shown in FIGS. 14 and 15, that mount electrical plate 30 to electrical box 72 or 102. Recessed portions 40 are provided where additional holes 38 maybe formed.

Electrical plate 30, may for example, be formed of plastic, metal, or another hard durable material. Surfaces 42 are angled with respect to surface 44. Threaded holes 46 are formed in surfaces 42 and 44 to receive each of the threaded plugs 36. Each threaded plug is provided with a “cross-like” recess 48 in order to engage a screwdriver or other tool capable of rotating plugs 36. Recess 48 is provided so that the screwdriver or other tool can rotate each plug 36 and either remove it or attach it to plate 30. Note that holes 32 are arranged in two hole patterns. A first hole pattern is provided to enable electrical plate 30 to mate with the holes 78 formed in a rectangular electrical box 72 shown in FIG. 14. A second hole pattern is provided to enable electrical plate 30 to mate with the holes 108 formed in a circular electrical box 102.

FIG. 2 illustrates a rear view of electrical plate 30 in accordance with a preferred embodiment of the invention. Holes 38 formed in electrical plate 30 extend all of the way through electrical plate 30 to enable screws 80, shown in FIGS. 14 and 15, to secure electrical plate 30 to an electrical box 72 or 102. Threaded holes 46 also extend all of the way through electrical plate 30 to enable electrical wires to extend from an external electrical device (shown in FIGS. 14 and 15) through to the interior to mate with electrical wires housed within electrical box 72 or 102. Electrical plate 30 generally has a concave portion, thereby forming recesses 50, 52 and 54 in the rear of electrical plate 30. Recesses 50 are formed in the circular plate cover portion 34. Recesses 52 are formed in the rectangular plate cover portion 32. Recess 54 is formed in the central portion of the electrical plate where rectangular and circular plate cover portions 32 and 34 overlap. Note in this rear view that the hybridization of rectangular and circular cover plate portions 32 and 34 is clearly visible. A threaded hole 69 is provided on the rear portion of electrical plate 30. Threaded hole 69 does not extend all of the way through plate 30 as do holes 38. Threaded hole 69 is provided as an attachment point for a ground wire to electrically ground electrical cover plate 30, in the event that electrical cover plate 30 is made of metal.

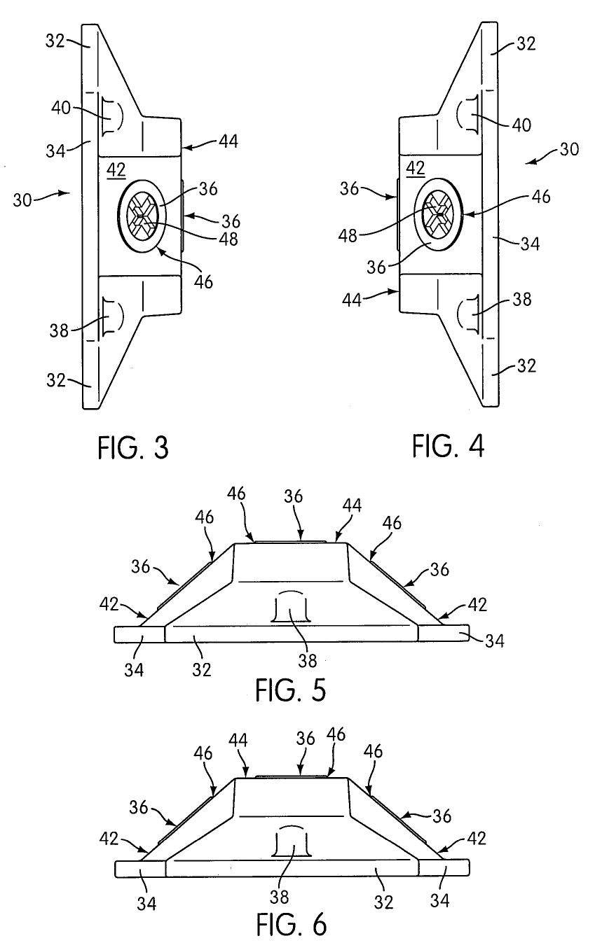

FIG. 3 illustrates a side view of electrical plate 30 in accordance with a preferred embodiment of the invention. Surface 44, which includes one of the threaded holes 46, is parallel to the rear surface of plate 30. Surfaces 42, each of which includes one of the threaded holes 46, are angled with respect to surface 44. FIG. 4 illustrates another side view of electrical plate 30 in accordance with a preferred embodiment of the invention. Threaded sockets 46 are provided to enable electrical devices to be securely attached to electrical plate 30. Threaded plugs 36 are provided to seal threaded holes 46 to prevent outside contaminants from entering electrical box 72 or 102 through threaded holes 46, until such time as it is desired to secure an electrical device to electrical plate 30 by threading it into one or more threaded holes 46.

FIGS. 5 and 6 illustrate bottom and top views of electrical plate 30 in accordance with a preferred embodiment of the invention. Surface 44 is parallel to the bottom surface of electrical plate 30. Surfaces 42 are angled with respect to surface 44. Consequently, threaded holes 46 formed in surfaces 42 are angled with respect to the threaded hole 46 formed in surface 44. Holes 38 in plate 30 are formed perpendicular to the bottom surface of plate 30.

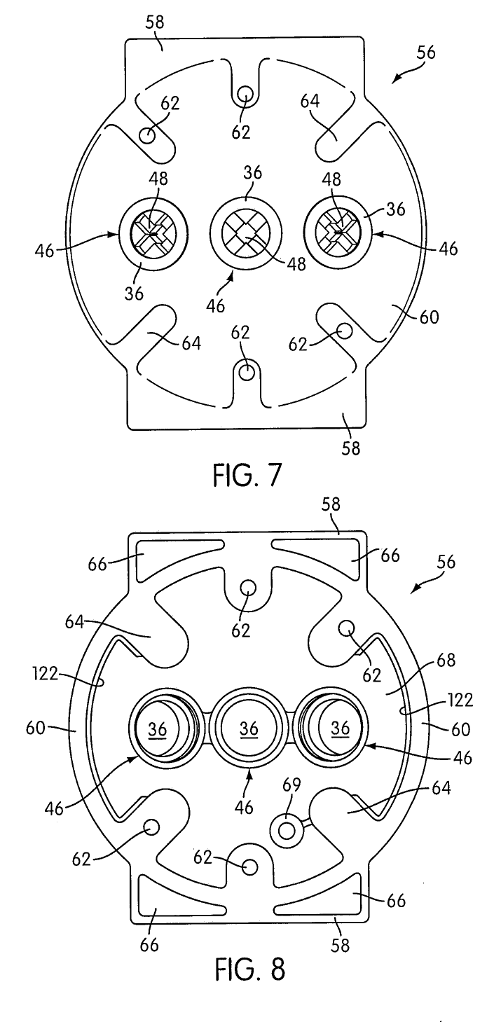

FIG. 7 illustrates a front view of an electrical plate 56 in accordance with an alternative embodiment of the invention. Electrical plate 56 is a cover used to mate with an electrical box 72 or 102 illustrated in FIGS. 14 and 15. Electrical plate 56 is a hybrid plate that includes both a rectangular plate cover portion 58 and a circular plate cover portion 60. Electrical plate 56 includes three threaded plugs 36 that mate with electrical plate 56. Various holes 62 are formed in electrical plate 56 to receive screws 80, shown in FIGS. 14 and 15, that mount electrical plate 56 to electrical box 72 or 102. Recessed portions 64 are provided where additional holes 38 may be formed. Note that holes 62 are arranged in two hole patterns. A first hole pattern is provided to enable electrical plate 56 to mate with the holes 78 formed in a rectangular electrical box 72 shown in FIG. 14. A second hole pattern is provided to enable electrical plate 56 to mate with the holes 108 formed in a circular electrical box 102.

Electrical plate 56, may for example, be formed of plastic, metal, or another hard durable material. Threaded holes 46 are formed circular plate cover portion 60 to receive each of the threaded plugs 36. Each threaded plug is provided with a “cross-like” recess 48 in order to engage a screwdriver or other tool capable of rotating plugs 36. Recess 48 is provided so that the screwdriver or other tool and rotate each plug 36 and either remove it or attach it to plate 56.

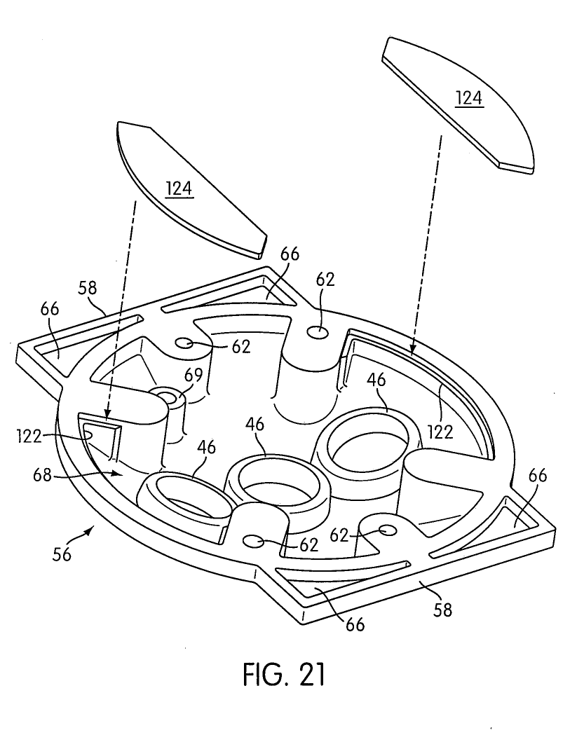

FIG. 8 illustrates a rear view of electrical plate 56 in accordance with an alternative embodiment of the invention. Electrical plate 56 has a convex configuration, thereby forming recesses 66 and 68 in the rear of electrical plate 56. Recesses 66 are formed in the rectangular plate cover portion 58. Recess 68 is formed in the circular plate cover portion 60. Threaded holes 46 extend through circular plate cover portion 60. As circular plate cover portion 60 is curved, threaded hole 46 is angled with respect to the other threaded holes 46. Thus, electrical devices may be attached to plate 56 at different angles. A threaded hole 69 is provided on the rear portion of electrical plate 56. Threaded hole 69 does not extend all of the way through plate 56 as do holes 38. Threaded hole 69 is provided as an attachment point for a ground wire to electrically ground electrical cover plate 56, in the event that electrical cover plate 56 is made of metal. Raised surfaces 122 form a shelf along the sides of recess 68. Raised surfaces provide support for plates 124 shown in FIG. 21. When plate 56 is combined with a rectangular electrical box 72, rear portions of recess 68 are exposed to the environment. Plates 124 cover those exposed portions of recess 68, thereby preventing contaminants from entering rectangular electrical box 72.

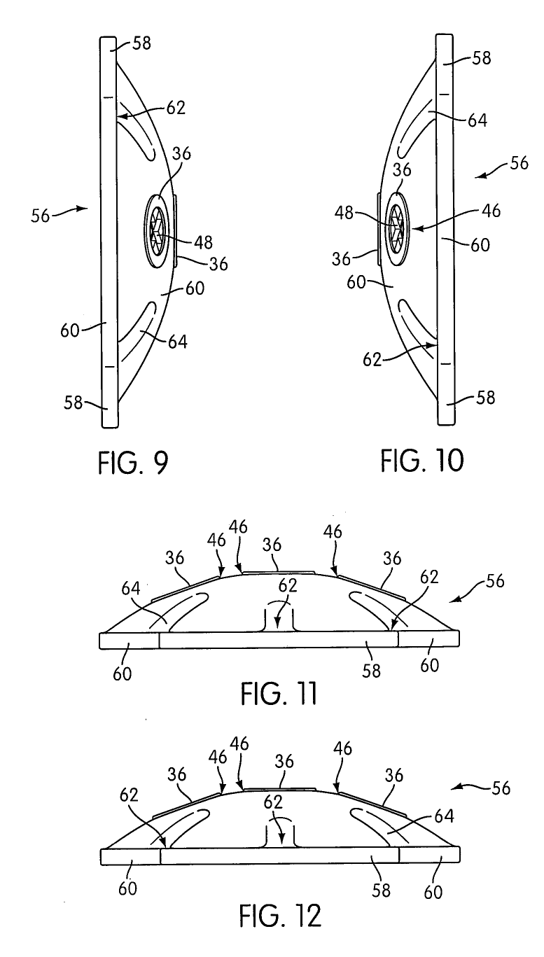

FIG. 9 illustrates a side view of electrical plate 56 in accordance with an alternative embodiment of the invention. FIG. 10 illustrates another side view of electrical plate 56 in accordance with an alternative embodiment of the invention. The convex shape of circular electrical plate portion 60 is visible in these Figures. In addition, these side views illustrate how the side threaded holes 36 are angled with respect to the center threaded hole 36. Each threaded plug is provided with a “cross-like” recess 48 in order to engage a screwdriver or other tool capable of rotating plugs 36. Recess 48 is provided so that the screwdriver or other tool and rotate each plug 36 and either remove it or attach it to plate 56.

FIG. 11 illustrates a bottom view of electrical plate 56 in accordance with an alternative embodiment of the invention. FIG. 12 illustrates a top view of electrical plate 56 in accordance with an alternative embodiment of the invention. In these views all three threaded plugs 36 are visible. Threaded plugs 36 are shown threaded into threaded holes 46. Holes 62 are provided so that screws 80 and secure plate 56 to a surface. Note that the longitudinal axis of each threaded plug is angled with respect to the other threaded plugs 36.

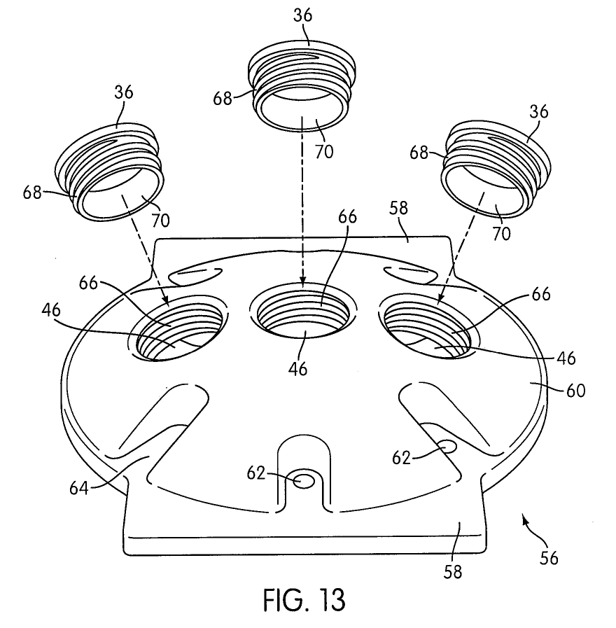

FIG. 13 illustrates a exploded view of electrical plate 56 and three threaded plugs 36 in accordance with an alternative embodiment of the invention. Each threaded plug 36 mates with threaded hole 46. Each threaded hole 46 includes threads 66 that engage with threads 68 formed on threaded plugs 3. Each threaded plug 36 includes a hollow recess 70 in the rear portion of the threaded plug, that faces electrical plate 56. While shown in connection with electrical plate 56, the configuration of threads 66 and 68 for threaded holes 46 and threaded plugs 36 is similar for electrical plates 30. Each threaded plug 36 is threadably connected to electrical plate 56 independent from the other threaded plugs 36.

FIG. 14 illustrates a exploded view of electrical plate 30 in accordance with a preferred embodiment of the invention and a rectangular electrical box 72 and lighted motion detector apparatus 83. Rectangular electrical box 72 is a conventional electrical outlet box made from pressed metal or plastic. Rectangular electrical box 72 is mounted within a wall, ceiling or floor and connects to electrical plate 30 or 56. Rectangular electrical box 72 is mounted in such a manner within the wall, ceiling or floor to enable electrical plate 30 or 56 to rest on the outer surface of that ceiling, wall or floor. Rectangular electrical box 72 includes plates 76 in which holes 78 are formed. Screws 80 pass through holes 38 formed in electrical plate 30 and engage holes 78 formed in rectangular electrical box 72. In this manner, screws 80 removably secure electrical plate 30 to rectangular electrical box 72.

In FIG. 14, threaded plugs 36 are removed from electrical plate 30, thereby exposing threaded holes 46. Threaded holes 46 are exposed to enable lighted motion detector apparatus 83 to be attached to electrical plate 30. Lighted motion detector apparatus 83 is one exemplary electrical device that may be attached to electrical plate 30. Electrical plate 30, having threaded holes 46, is configured to mate with any electrical device that has a threaded base configured to mate with threaded holes 46.

Lighted motion detector apparatus 83 includes a pair of light bulbs 84, a pair of light bulb covers 86, bases 88, pivot joints 90, and threaded couplers 92. Threaded coupler supports 91 extend between pivot joints 90 and threaded couplers 92. Light bulbs 84 may be outdoor or indoor light bulbs that are attached to lighted motion detector apparatus 83 at bases 88. Light bulb covers 86 extend from bases 86 up to the front of light bulbs 84 to provide protection to the sides of light bulbs 84 from damage. Threaded couplers 92 are threaded into threaded holes 46, thereby securing lights bulbs 84 to electrical plate 30. Pivot joints 90 enable lights 84 to be angled with respect to electrical plate 30. Threaded couplers 92 attach to the threaded holes 46 formed in surfaces 42.

Motion detector 94 is attached to a neck 96 that is mounted to a base 98. A threaded coupler 100 is provided at the rear of base 98. Threaded coupler 100 threadably engages the threaded hole 46 in surface 44. As the surfaces 42 are angled with respect to surface 44, lights 84 are angled away from motion detector 94 when mounted to electrical plate 30. Once connected to electrical plate 30, threaded couplers 92 and 100 seal off the threaded holes 46, thereby preventing environmental contaminants from entering into rectangular electrical box 72. Note that in FIG. 14, rectangular profile cover portions 32 extend to cover the entire frontal rectangular profile of rectangular electrical box 72.

FIG. 15 illustrates an exploded view of electrical plate 56 in accordance with an alternative embodiment of the invention and a circular electrical box 102 and lighted motion detector apparatus 83. Circular electrical box 102 includes prongs 104 having holes 106. Prongs 104 are rigidly attached to circular electrical box 102. Prongs 104 are used to secure circular electrical box to a surface such as a wooden or aluminum stud in a wall or ceiling. Nails or screws (now shown) then extend through holes to secure circular electrical box 102 to the stud or other supporting surface. A plurality of threaded cylinders 108 are provided to threadably engage screws or bolts 80, thereby securing electrical plate 56 to circular electrical box 102.

Note that the circular plate cover portion 60 of electrical plate 56 covers circular electrical box 102. The rectangular plate cover portion 58 of electrical plate 56 enables electrical plate 56 to cover rectangular electrical box 72 shown in FIG. 14. Together, circular plate cover portion 60 and rectangular plate cover portion 58 form an external profile that covers both rectangular electrical box 72 and circular electrical box 102. Similarly, the circular plate cover portion 34 of electrical plate 30, shown in FIG. 14, covers circular electrical box 102 shown in FIG. 15. Together, circular plate cover portion 34 and rectangular plate cover portion 32 form an external profile that covers both rectangular electrical box 72 and circular electrical box 102. Thus, by each electrical plate 30 and 56 having rectangular and circular cover profile portions, 32 and 34 for electrical plate 30 and 58 and 60 for electrical plate 56, each electrical plate 30 and 56 is capable of mating with and covering either rectangular electrical box 72 or circular electrical box 102. Further, the placement of holes 38 and 62 in electrical plates 30 and 56 enable each electrical plate 30 and 56 to be mated with and attached to either rectangular electrical box 72 or circular electrical box 102 with screws 80.

Referring again to electrical plate 56, circular plate cover portion 60 has a convex shape. Thus, the axis of each threaded hole 46 is angled with respect to the other threaded holes 46. As a result, when lighted motion detector 83 is mounted to electrical plate 56, lights 84 are angled away from motion detector sensor 94.

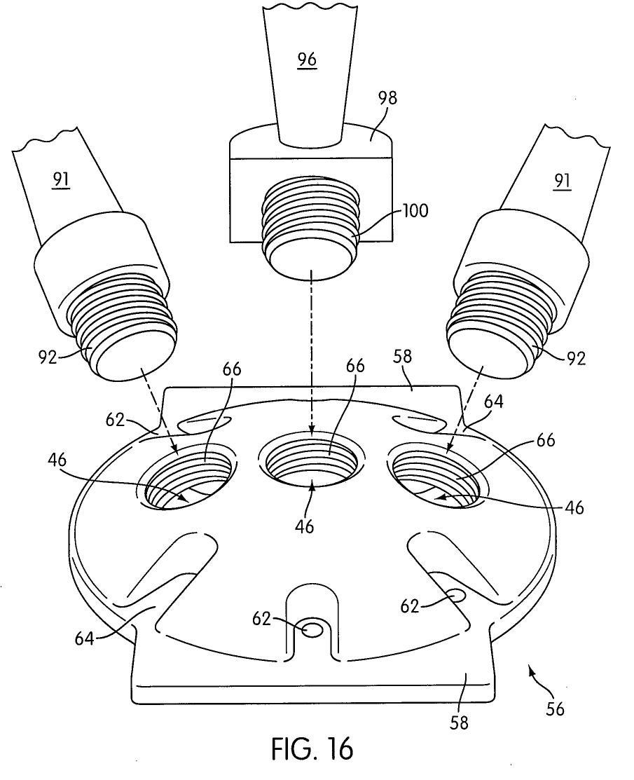

FIG. 16 illustrates a exploded view of an electrical plate 56 and three threaded bases 92 and 100 of a lighted motion detector apparatus 83 in accordance with an alternative embodiment of the invention. Threaded couplers 92 of lights 94 are shown with threaded coupler supports 91 that extend between pivot joints 90 and threaded couplers 92. Note that threaded couplers 92 mate with the threads 66 of the side threaded holes 46 that angle away from central threaded hole 46 that receives threaded coupler 100, that is attached to the neck 96 and base 98 of motion detector sensor 94. Holes 62 for receiving screws 80 are shown formed in electrical plate 56. Threaded holes 46 are angled with respect to each other due to the curvature of circular plate cover portion 60.

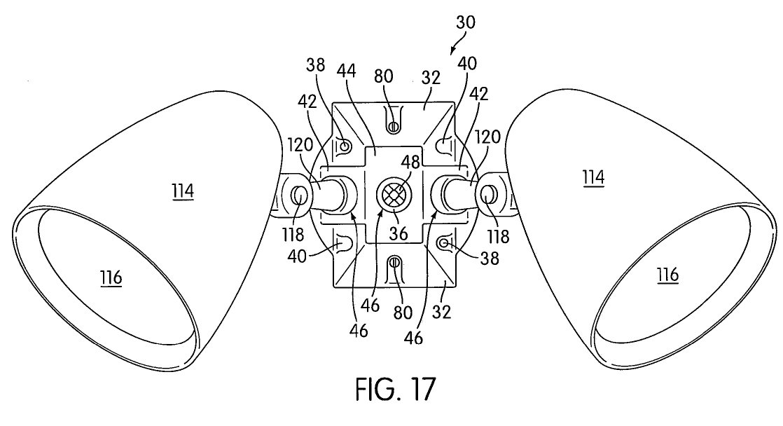

FIG. 17 illustrates a front view of an electrical plate 30 in accordance with a preferred embodiment of the invention and a pair of lights 116. Lights 116 having protective covers 114 that are mounted to pivot joints 118. Pivot joints 118 connect protective covers 114 to bases 120. Bases 120 have threaded ends that threadably engage threaded holes 46, thereby connecting lights 116 to electrical plate 118. Note that threaded plugs 36 are removed from the two side threaded holes 46 formed in surfaces 42. However, as there is no motion detector 94 in this example, a threaded plug 36 remains inserted into threaded hole 36 formed in surface 44 to prevent contaminants from entering electrical box 72 or 102. Pivot joints 118 enable lights 116 to be pivoted with respect to electrical plate 30. Please note that the illustration of lights 116 is merely exemplary and any type of electrical device having a threaded base capable of coupling to threaded holes 46 may be used in combination with electrical plate 30 or 56. Note that as holes 46 formed in surfaces 42, lights 116 are angled away from each other. Screws 80 secure electrical plate 56 to an electrical box 72 or 102.

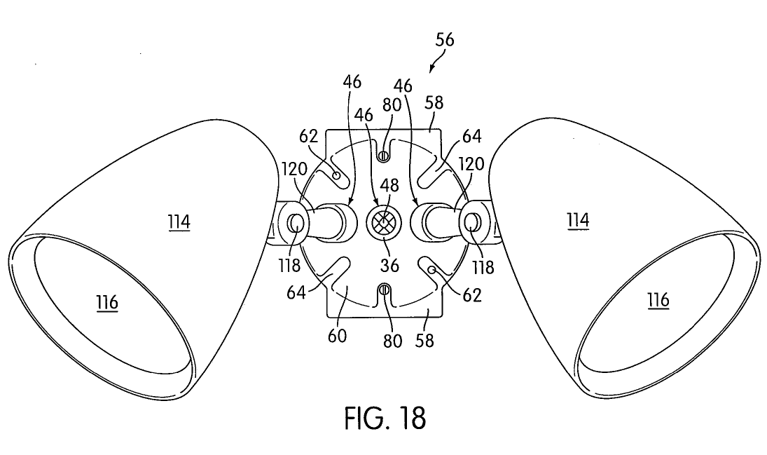

FIG. 18 illustrates a front view of an electrical plate 56 in accordance with an alternative embodiment of the invention and a pair of lights 116. Lights 116 are secured to electrical plate 56 by bases 120 that are threadably engaged to threaded holes 46. Note that a threaded plug 36 is placed in the center threaded hole 46 to prevent any contaminants to enter electrical box 72 or 102. Please note that the illustration of lights 116 is merely exemplary and any type of electrical device having a threaded base capable of coupling to threaded holes 46 may be used in combination with electrical plate 30 or 56. Note that as holes 46 formed in the curved circular plate cover portion 60, lights 116 are angled away from each other. Screws 80 secure electrical plate 56 to an electrical box 72 or 102.

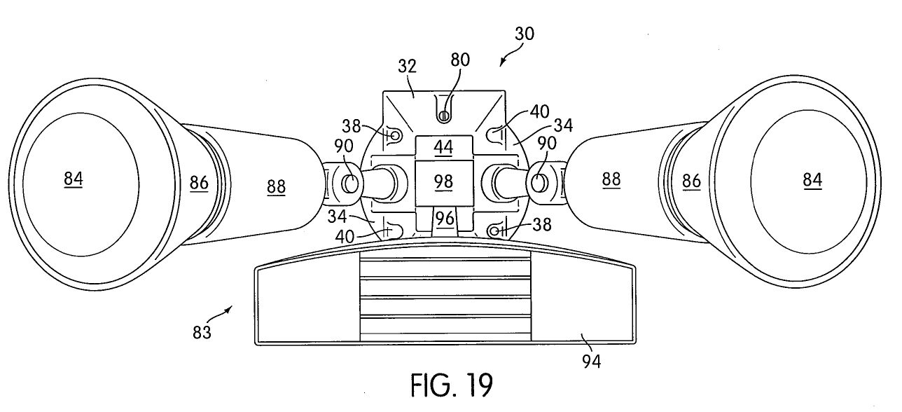

FIG. 19 illustrates a front view of an electrical plate 30 in accordance with a preferred embodiment of the invention and a lighted motion detector apparatus 83. Lighted motion detector apparatus is shown completely attached to electrical plate 30. Screws 80 secure electrical plate 80 to an electrical box 72 or 102. Note that all three plugs 36 have been removed from electrical plate 30 to accommodate motion detector apparatus 83.

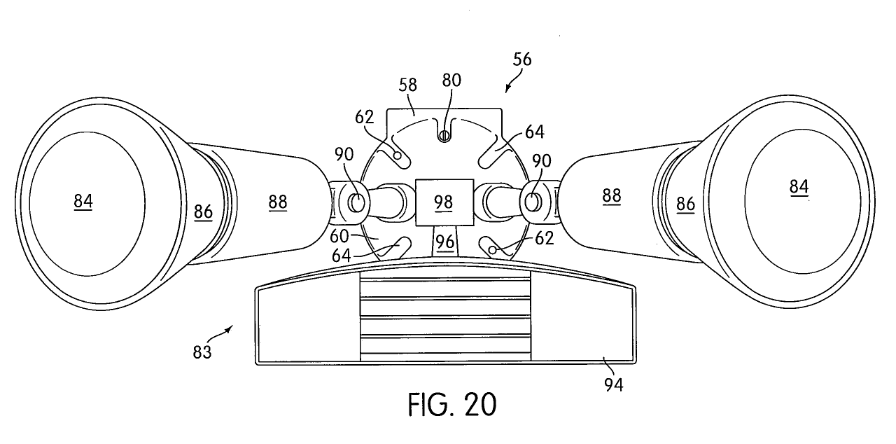

FIG. 20 illustrates a front view of an electrical plate 56 in accordance with an alternative embodiment of the invention and a lighted motion detector apparatus 83. Lighted motion detector apparatus is shown completely attached to electrical plate 56. Screws 80 secure electrical plate 80 to an electrical box 72 or 102. Note that all three plugs 36 have been removed from electrical plate 56 to accommodate motion detector apparatus 83.

FIG. 21 illustrates a rear perspective view of an electrical plate 56 in accordance with an alternative embodiment of the invention. Raised surfaces 122 form a shelf along the sides of recess 68. Raised surfaces provide support for plates 124. When plate 56 is combined with a rectangular electrical box 72, rear portions of recess 68 are exposed to the environment. Plates 124 cover those exposed portions of recess 68, thereby preventing contaminants from entering rectangular electrical box 72.

While the invention has been shown and described with reference to a particular embodiment thereof, it will be understood to those skilled in the art, that various changes in form and details may be made therein without departing from the spirit and scope of the invention.

What is claimed is:

1. A plate for covering either a rectangular electrical box or a circular electrical box, comprising:
a circular plate cover portion configured to cover a circular electrical box; and
a rectangular plate cover portion configured to cover a rectangular electrical box.

2. The plate of claim 1, further comprising a first threaded hole formed in the plate for receiving an electrical device.

3. The plate of claim 1, wherein a plurality of holes are formed in the plate for receiving a fastener to secure the plate to the circular or rectangular electrical box.

4. The plate of claim 3, wherein the plurality of holes includes a first pattern of holes configured to match the hole pattern of the circular electrical box.

5. The plate of claim 3, wherein the plurality of holes includes a second pattern of holes configured to match the hole pattern of the rectangular electrical box.

6. The plate of claim 2, further comprising a threaded plug configured to mate with the threaded hole.

7. The plate of claim 2, further comprising a second threaded hole and a third threaded hole, wherein the first threaded hole has an axis perpendicular to a rear surface of the plate, and wherein the second and third threaded holes have an axis that is angled with respect to the axis of the first threaded hole.

8. An electrical plate configured to mate with both a circular electrical box and a rectangular electrical box, wherein said electrical plate has an exterior profile configured to cover both the circular electrical box and the rectangular electrical box.

9. The plate of claim 8, further comprising a first threaded hole formed in the plate for receiving an electrical device.

10. The plate of claim 8, wherein a plurality of holes are formed in the plate for receiving a fastener to secure the plate to the circular or rectangular electrical box.

11. The plate of claim 10, wherein the plurality of holes includes a first pattern of holes configured to match the hole pattern of the circular electrical box.

12. The plate of claim 10, wherein the plurality of holes includes a second pattern of holes configured to match the hole pattern of the rectangular electrical box.

13. The plate of claim 9, further comprising a threaded plug configured to mate with the threaded hole.

14. The plate of claim 9, further comprising a second threaded hole and a third threaded hole, wherein the first threaded hole has an axis perpendicular to a rear surface of the plate, and wherein the second and third threaded holes have an axis that is angled with respect to the axis of the first threaded hole.

15. An electrical plate for covering a round electrical box or a rectangular electrical box, said electrical plate comprising:
a plate having two ends and two sides, each end having three flat edges configured to match a configuration of the rectangular electrical box, each side having curved edges configured to match a configuration of the round electrical box.

16. The plate of claim 15, further comprising a first threaded hole formed in the plate for receiving an electrical device.

17. The plate of claim 15, wherein a plurality of holes are formed in the plate for receiving a fastener to secure the plate to the circular or rectangular electrical box.

18. The plate of claim 17, wherein the plurality of holes includes a first pattern of holes configured to match the hole pattern of the circular electrical box.

19. The plate of claim 17, wherein the plurality of holes includes a second pattern of holes configured to match the hole pattern of the rectangular electrical box.

20. The plate of claim 16, further comprising a threaded plug configured to mate with the threaded hole.

21. The plate of claim 16, further comprising a second threaded hole and a third threaded hole, wherein the first threaded hole has an axis perpendicular to a rear surface of the plate, and wherein the second and third threaded holes have an axis that is angled with respect to the axis of the first threaded hole.

22. The plate of claim 15, further comprising a pair of plates configured to mate with a rear portion of the electrical plate at the sides having curved edges configured to match a configuration of the round electrical box.
